(19) United States
(12) Patent Application Publication
(10) Pub. No.: US 2012/0178037 A1
(43) Pub. Date: Jul. 12, 2012

(54) ROLLER SEALING DEVICE AND GAS-SEALING METHOD THEREOF

(75) Inventors: A-TZU CHEN, TAIPEI COUNTY (TW); MING-HUI YU, TAIPEI CITY (TW); CHANG-FA CHEN, TAOYUAN COUNTY (TW); WANG-TSUNG LIANG, TAOYUAN COUNTY (TW); CHIA-JUNG KAO, TAIPEI CITY (TW)

(73) Assignee: TANGTECK EQUIPMENT INC., TAOYUAN COUNTY (TW)

(21) Appl. No.: 12/986,358

(22) Filed: Jan. 7, 2011

(51) Int. Cl. F27D 7/00; F27B 9/30

(52) U.S. Cl. 432/22; 432/74

(57) ABSTRACT

A roller sealing device arranged at an access port of a continuous furnace for adapting a continuous processed planar processed material. The rolling device includes a pair of first roller carriers arranged correspondingly opposite to each other, each having a first roller assembly. Each first roller carrier includes a first sealing roller and two first auxiliary rollers; the first sealing roller and two first auxiliary rollers are pivoted to a respective one of the first roller carriers; the two first auxiliary rollers are located between the first sealing roller and the corresponding first roller carrier. The first auxiliary rollers rollingly abut against the first sealing roller and the corresponding first roller carrier. Therefore, the roller sealing device is sealed well so as to prevent the gas from leakage. The present invention further provides a gas-sealing method.

### BACKGROUND OF THE INVENTION

1. Field of the Invention

The present invention relates to a roller sealing device, in particular, to a roller sealing device arranged at an entrance or/and exit of a continuous furnace with a continuous planar processed material applied thereto, and to a gas-sealing method thereby.

2. Description of Related Art

Conventionally, there is a sealing device arranged at entrance or/and exit of a continuous furnace applied with continuous planar processed material, to prevent from the gas leaking outwards from internal of the continuous furnace. Conventional sealing method is to simply put a curtain at the entrance thereof, and it is not a useful preclusion. For nontoxic gas, the conventional sealing method is just acceptable; but for toxic gas, it's full of leakage hazards.

### SUMMARY OF THE INVENTION

In view of the aforementioned issues, the issue to the present invention is to create a perfect seal device and gas-sealing method in order to prevent from the leakage.

To achieve the above-mentioned objectives, the present invention provides a roller sealing device, arranged at an entrance or/and exit of a continuous furnace applied with a continuous planar processed material. The roller sealing device includes two first roller carriers opposite to each other, and two first roller assemblies opposite to each other. Each first roller assembly includes a first sealing roller and two first auxiliary rollers. The first sealing roller and two first auxiliary rollers are pivoted to a respective one of the first roller carriers; the two first auxiliary rollers are located between the first sealing roller and the corresponding first roller carrier. The first auxiliary rollers abut against the first sealing roller and the corresponding first roller carrier.

To achieve the above-mentioned objectives, the present invention provides a roller sealing device, arranged at an entrance or/and exit of a continuous furnace applied with a continuous planar processed material. The roller sealing device includes two first roller carriers opposite to each other, two first roller assemblies opposite to each other, two second roller carriers opposite to each other, and two second roller assemblies opposite to each other. Each first roller assembly includes a first sealing roller and two first auxiliary rollers. The first sealing roller and two first auxiliary rollers are pivoted to a respective one of the first roller carriers; the two first auxiliary rollers are located between the first sealing roller and the corresponding first roller carrier. The first auxiliary rollers abut against the first sealing roller and the corresponding first roller carrier. Two second roller carriers are disposed at a lateral side of the two first roller carriers. Each second roller assembly includes a second sealing roller and two second auxiliary rollers. The second sealing roller and two second auxiliary rollers are pivoted to a respective one of the second roller carriers; the two second auxiliary rollers are located between the second sealing roller and the corresponding second roller carrier. The second auxiliary rollers abut against the second sealing roller and the corresponding second roller carrier. A negative pressure area is arranged among the two first roller carriers, the two first roller assemblies, the two second roller carriers and two second roller assemblies.

To achieve the above-mentioned objectives, the present invention provides a gas-sealing method. To abut against the upper surface and lower surface of the continuous planar processed material via the two first sealing rollers of the two first roller assemblies respectively is met, while the two second sealing rollers of the two second roller assemblies abut against the upper surface and lower surface of the continuous planar processed material respectively. Then, the first gas access port is used to convey highly-pressured gas to form the positive pressure among the first auxiliary rollers and the two first roller carriers while the second gas access port is used to suck the gas to form the negative pressure among the second auxiliary rollers and the second roller carriers, so that the reaction region is prevented from gas leakage.

It is worth mentioning as followed:

The close contacts between the first sealing roller of one first roller assembly and the upper surface of the continuous planar processed material; and between the first sealing roller of the other first roller assembly and the lower surface of the continuous planar processed material are achieved. The close contacts respectively between each first sealing roller and the first auxiliary rollers are achieved. This arrangement provides a more ideal seal structure. Especially, the pair of first auxiliary rollers serves to double the sealing effect when both are closely abutting the first sealing roller on the first roller carrier. This perfect seal structure prevents the gas from leaking and dissipating outwardly, and is preferable to applied to keep the toxic gas in the continuous furnace.

A further arrangement is provide to keep the whole device better sealed is to put a gas access port between the first auxiliary rollers and each first roller carrier.

The arrangement of the two second roller carriers and the two second roller assemblies is to create another gas sealing structure. The negative pressure area is arranged to suck the gas dissipated from the first roller carriers and the first roller assemblies and to keep the gas sealed between the second roller carriers and the second roller assemblies.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a perspective view of a roller sealing device of a first preferred embodiment according to the present invention;

FIG. 2 is a side view of FIG. 1.

FIG. 3 is a perspective view of a roller sealing device of a second preferred embodiment according to the present invention;

FIG. 4 is a perspective view of a roller sealing device of a third preferred embodiment according to the present invention; and

FIG. 5 is a flowchart of a gas-sealing method according to the present invention.

### DETAILED DESCRIPTION OF THE PREFERRED EMBODIMENTS

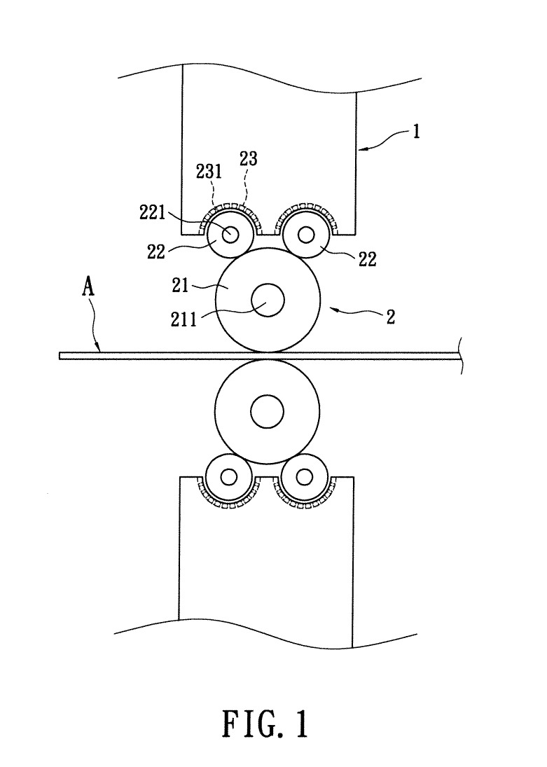

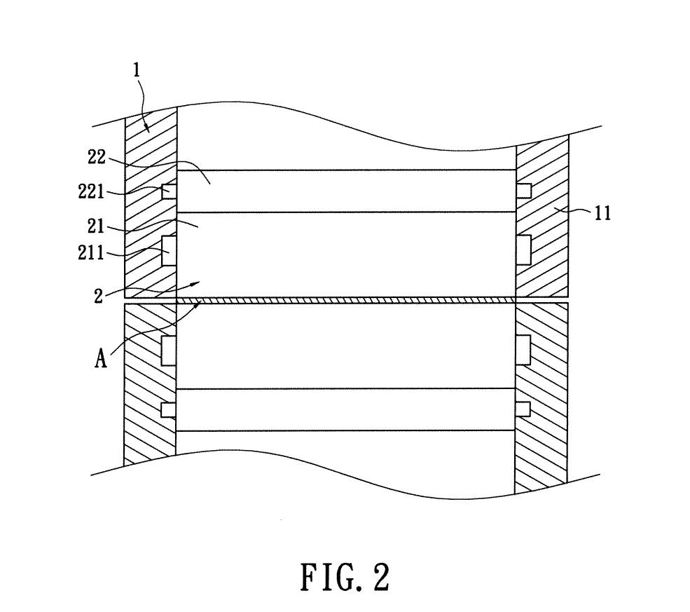

Referring now to FIGS. 1 and 2, in which a roller sealing device arranged at an entrance or/and exit (i.e., access port) of a continuous furnace applied with a continuous planar processed material A is disclosed. There is no restrain to any type of the continuous furnace, such as the diffusion furnaces, the heat treatment equipments, the coaters, and the like. The rolling device includes two first roller carriers 1 opposite to each other to define a passage to access the continuous planar processed material A, and two first roller assemblies 2 opposite to each other. In the first preferred embodiment, the continuous planar processed material A is conveyed horizontally in a roll-to-roll manner. The two first roller carriers 1 are arranged in an upper-and-lower manner and disposed beneath and above the continuous planar processed material A respectively. Each first roller carrier 1 defines two lateral sidewalls 11, which are pivoted to a respective one of the first roller assembly 2.

Each first roller assembly 2 includes a first sealing roller 21 and two first auxiliary rollers 22. The first sealing roller 21 defines an axle 211 having two ends, which are pivoted to the two lateral sidewalls 11 of the corresponding first roller carrier 1. Each first auxiliary roller 22 defines an axle 221 having two ends, which are pivoted to the two lateral sidewalls 11 of the corresponding first roller carrier 1. The pivot manner thereto could be accomplished by adapting with the bearing member or the likes (not shown), and there is no further detail described because it is convention prior art. The first auxiliary roller 22 locates between the first sealing roller 21 and the first roller carrier 1. The peripheral of each first auxiliary roller 22 abuts against the first sealing roller 21 and the first roller carrier 1.

The first roller carrier 1, the first sealing roller 21 and the first auxiliary roller 22 could be made of different materials. Usually, the first sealing roller 21 is made of soft materials; while the first auxiliary roller 22 is made of hard material. It is still not a restrain to the materials applied thereto though. The materials of first sealing roller 21 and the first auxiliary roller 22 vary by adapting to the temperature of the texture of the continuous planar processed material A. The first sealing roller 21 could be made of rubber or silicon thereby in order to keep the continuous planar processed material A away from damage. The first auxiliary roller 22 and the first roller carrier 1 could be made of metals or materials of low friction coefficient, so that the frictional abrasion of the first auxiliary roller 22 and the first roller carrier 1 is decreased thereby.

For further gas tightness between each first auxiliary roller 22 and the first roller carrier 1, there is at least one first gas access port 23 is formed between the first auxiliary rollers 22 and the first roller carriers 1, i.e., the first gas access port 23 can be arranged on the first roller carrier 1 and adjacent to the corresponding first auxiliary roller 22. In this embodiment, the first gas access port 23 is a porous structure, which could be made by the ceramics or powder metallurgy technology. The first gas access port 23 is able to include a gas outlet 231, such as a plurality of ventilators connecting a pressure generator, for example a gas-providing source (not shown) for applying highly-pressured gas to the first gas access port 23. The pressured gas is conveyed to where between the first roller carrier 1 and the first auxiliary rollers 22, in order to form a positive pressure state (a kind of gaseous film), which is capable of preventing the disposal gas generated in the reaction region of the continuous furnace from leaking via the conjunction between the first roller carrier 1 and the first auxiliary rollers 22. The ventilators 231 could be replaced by the grooves (not shown). Moreover, the first gas access port 23 is able to connect to a gas extraction device, e.g., an negative pressure generator (not shown) for sucking the gas out of where between the first roller carrier 1 and the first auxiliary rollers 22, in order to form a negative pressure state to prevent the disposal gas generated in the reaction region of the continuous furnace from leaking via the conjunction between the first roller carrier 1 and the first auxiliary rollers 22.

The continuous planar processed material A is conveyed horizontally. When the continuous planar processed material A passes through the entrance and exit of the continuous furnace along the passage, the two first sealing rollers 21 of each first roller assembly 2 respectively abut against an upper surface and a lower surface of the continuous planar processed material A. Each first sealing roller 21 also contacts tightly with the two first auxiliary rollers 22, so that the tight and close contacts are applied to two places respectively, one is between the continuous planar processed material A and each first sealing roller 21, and the other is between each first sealing roller 21 and the corresponding two first auxiliary rollers 22. The arrangement of the first auxiliary rollers 22 is helpful to keep the seal status, and to offer gas sealing even twice by the close contacts respectively via the first sealing rollers 21 and via the first roller carriers 1, so that the gas is prevented from leaking and dissipating outwardly. Moreover, the arrangement of the gas access ports 23 between the first auxiliary rollers 22 and each corresponding first roller carrier 1 is to keep the whole device further sealed.

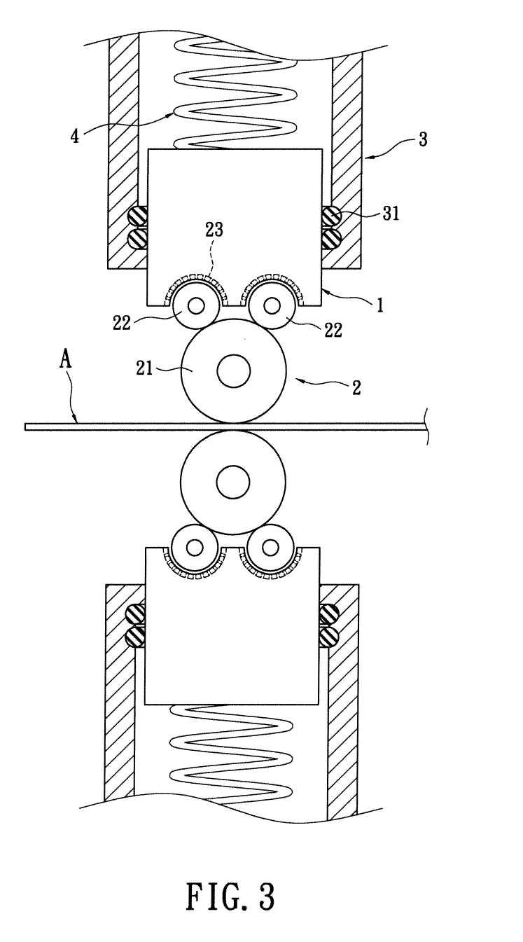

With respect to FIG. 3, an elastic member 4 is further disclosed and disposed between the corresponding first roller carrier 1 and the continuous furnace 3. The elastic member 4 compresses upon the first roller carrier 1, so that each first roller carrier 1 and the corresponding first roller assemblies 2 thereof connect to the continuous furnace 3 resiliently. Therefore, the two first sealing rollers 21 of the first roller assemblies 2 could adapt themselves to the continuous planar processed material A by abutting resiliently against the upper surface and the lower surface of the continuous planar processed material A in a respective manner. An enclosure member 31 is further disclosed and arranged between each first roller carrier 1 and the continuous furnace 3, in order to improve the capability of gas tightness. Moreover, a fine-adjustment mechanism (not shown) could be further disclosed and arranged between each first roller carrier 1 and the continuous furnace 3, so that the first roller carriers 1 and the first roller assemblies 2 are capable of adjustment.

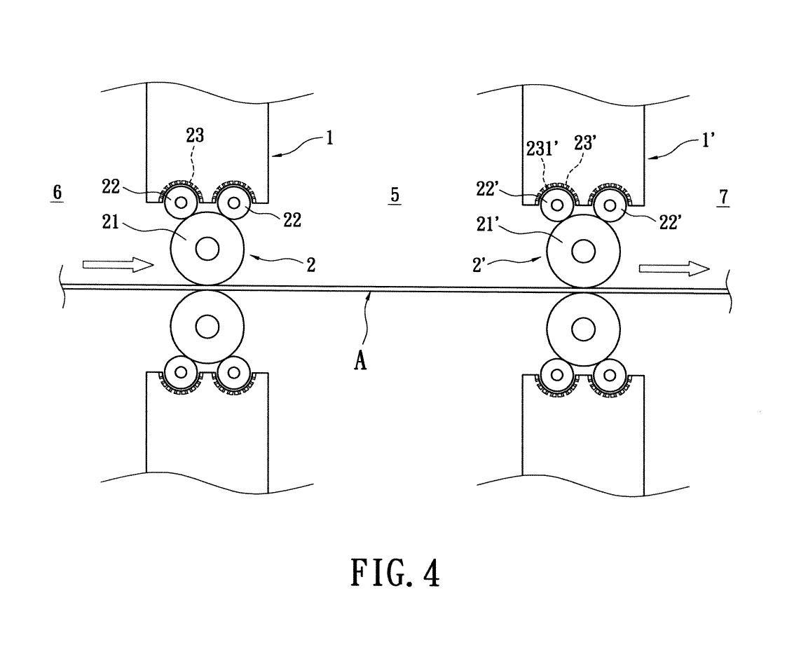

With respect to FIG. 4, the roller sealing device further includes two second roller carriers 1′ and two second roller assemblies 2′. The two second roller carriers 1′ opposite to each other to define the passage similarly with the first roller carriers 1, and disposed at a lateral side of the two first roller carriers 1. The two second roller assemblies 2′ are opposite to each other. Each second roller assembly 2′ includes a second sealing roller 21′ and two second auxiliary rollers 22′; the second sealing roller 21′ and two second auxiliary rollers 22′ are pivoted to a respective one of the second roller carriers 1′. The two second auxiliary rollers 22′ are located between the second sealing roller 21′ and the corresponding second roller carrier 1′. The peripheral of the second auxiliary rollers 22′ abuts against the second sealing roller 21′ and the corresponding second roller carrier 1′. The two first roller carriers 1′ are arranged in an upper-and-lower manner and disposed beneath and above the continuous planar processed material A respectively. The second sealing rollers 21′ of the two second roller assemblies 2′ abut against the upper surface and the lower surface of the continuous planar processed material A respectively. Each second roller carrier 1′ includes a second gas access port 23′, which is adjacent to the corresponding second auxiliary roller 22′. The second gas access port 23′ is a porous structure, and includes a plurality of gas extraction outlet 231′, such as plurality of ventilators. The second gas access port 23′ is connected to another gas supply or a negative pressure generator. Because of the similarity of the configuration and the function between the first roller carriers 1 and the first roller assemblies 2, the detailed description for the second roller carriers 1′ and the second roller assemblies 2′ is omitted.

A negative pressure area 5 is further arranged among the two first roller carriers 1, the two first roller assemblies 2, the two second roller carriers 1′ and two second roller assemblies 2′. In case that the negative pressure area 5, which is of negative pressure, is capable of keeping the gas retained therein, if the gas leaks from the reaction region. A secondary seal effect resulted from each second roller carrier 1′ and the corresponding two second roller assemblies 2′ further avoid the retained gas running out, in order to meet highly-requested sealing.

With respect to FIG. 4, the roller sealing device is arranged at an entrance of the continuous furnace, which means the area at the left hand side of the two first roller carriers 1 and the two first roller assemblies 2 is defined as a furnace external region 6, and the area at the right hand side of the two first roller carriers 1′ and the two first roller assemblies 2′ is defined as a reaction region 7 set inside the furnace. If the roller sealing device is arranged at an exit of the continuous furnace, the furnace external region 6 and the reaction region 7 should be swapped.

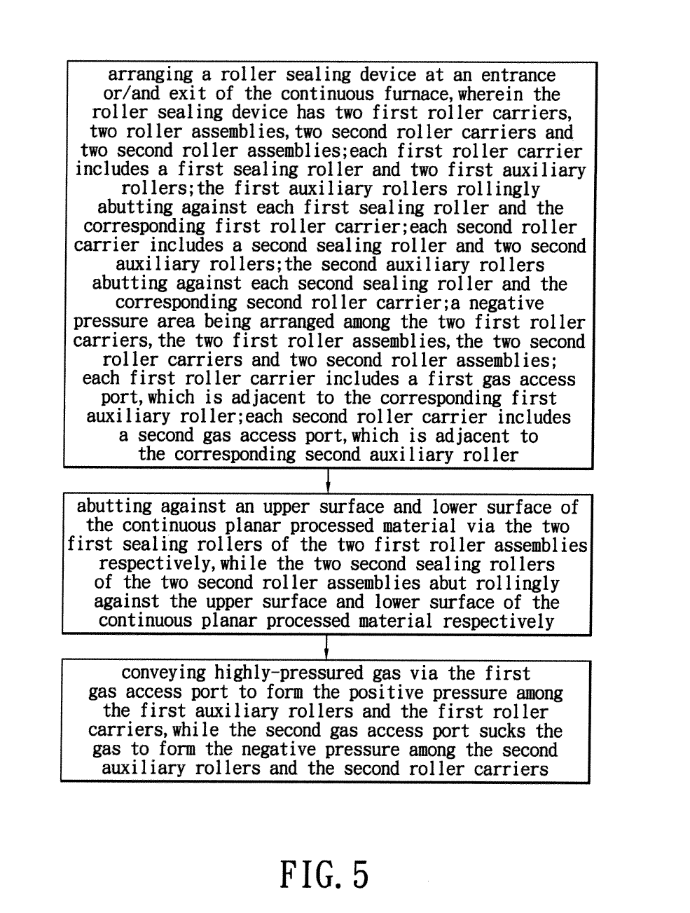

Referring to FIGS. 4 and 5, there is a gas-sealing method using the roller sealing device to adapt to various pressures in the reaction region 7. For example, when the reaction region 7 is under the negative pressure, which means the pressure of the furnace external region 6 is higher than that of the negative pressure area 5 while the pressure of the negative pressure area is higher than that of the reaction region 7, the method includes steps as followed:

First, to arrange the roller sealing device at the entrance or/and exit of the continuous furnace is done, wherein the roller sealing device has two first roller carriers 1, two roller assemblies 2, two second roller carriers 1′ and two second roller assemblies 2′. The embodiments of the roller sealing device are described as above, and there would be no further mention.

To abut against the upper surface and lower surface of the continuous planar processed material A via the two first sealing rollers 21 of the two first roller assemblies 2 respectively is met, while the two second sealing rollers 21′ of the two second roller assemblies 2′ abut against the upper surface and lower surface of the continuous planar processed material A respectively.

Then, the first gas access port 23 is used to convey highly-pressured gas to form the positive pressure among the first auxiliary rollers 22 and the two first roller carriers 1 while the second gas access port 23′ is used to suck the gas to form the negative pressure among the second auxiliary rollers 22′ and the second roller carriers 1′, so that the reaction region 7 is prevented from gas leakage.

When the reaction region 7 is in the positive pressure, which means the pressure of the reaction region 7 is higher than that of furnace external region 6 while the pressure of the furnace external region 6 is higher than that of the negative pressure area 5, the method according to the embodiments is also adapted thereto. The first and second gas access port s 23 and 23′ are not restrained to positive or negative pressure. For example, the first gas access port s 23 could be negative pressure, the second gas access port 23′ could be positive pressure. The utilization of the pressure variation is offered to the gas sealing structure.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A roller sealing device arranged at an access port of a continuous furnace for adapting a continuous planar processed material, comprising:
a pair of first roller carriers arranged correspondingly opposite to each other, each roller carrier comprising a first roller assembly having a first sealing roller and two first auxiliary rollers, a passage being defined between the pair of first roller carriers,
wherein the rolling axis of the first sealing roller situates parallel between the rolling axes of the two first auxiliary rollers,
wherein the rolling axis of the first sealing roller situates between the rolling axes of the two first auxiliary rollers and the passage,
wherein the first auxiliary rollers rollingly abut against the first sealing roller.

2. The roller sealing device according to claim 1, wherein the two first roller carriers are arranged in an upper-and-lower manner and disposed beneath and above the continuous planar processed material respectively; the two first sealing rollers of the two first roller assemblies rollingly abut against an upper surface and a lower surface of the continuous planar processed material respectively.

3. The roller sealing device according to claim 1, wherein each first roller carrier includes a first gas access port adjacent to the corresponding first auxiliary roller.

4. The roller sealing device according to claim 3, wherein the first gas access port is a porous structure; the first gas access port includes a plurality of ventilators and connects an gas supply or a negative pressure generator.

5. The roller sealing device according to claim 1, further including an elastic member disposed between the each first roller carrier and the continuous furnace, so that the two first roller carriers and the two first roller assemblies connect to the continuous furnace resiliently.

6. The roller sealing device according to claim 1, wherein the roller sealing device is disposed at an entrance of the continuous furnace, and another roller sealing device is disposed at an exit of the continuous furnace.

7. A roller sealing device, arranged at an access port of a continuous furnace for adapting a continuous planar processed material, comprising:
a pair of first roller carriers arranged correspondingly opposite to each other, each roller carrier comprising a first roller assembly having a first sealing roller and two first auxiliary rollers, a passage being defined between the pair of first roller carriers,
wherein the rolling axis of the first sealing roller situates parallel between the rolling axes of the two first auxiliary rollers,
wherein the rolling axis of the first sealing roller situates between the rolling axes of the two first auxiliary rollers and the passage,
wherein the first auxiliary rollers rollingly abut against the first sealing roller; and
a pair of second roller carriers arranged sequentially with respect to the first roller carries, the second roller carriers arranged correspondingly opposite to each other, each roller carrier comprising a second roller assembly having a second sealing roller and two second auxiliary rollers, the passage being defined between the pair of second roller carriers,
wherein a gas extraction outlet is formed between the second auxiliary rollers and the second roller carriers,
wherein the rolling axis of the second sealing roller situates parallel between the rolling axes of the two second auxiliary rollers,
wherein the rolling axis of the second sealing roller situates between the rolling axes of the two second auxiliary rollers and the passage,
wherein the second auxiliary rollers rollingly abut against the second sealing roller.

8. The roller sealing device according to claim 7, wherein the two first roller carriers are arranged in an upper-and-lower manner and disposed respectively beneath and above the continuous planar processed material; the two first sealing rollers of the two first roller assemblies respectively and rollingly abut against an upper surface and a lower surface of the continuous planar processed material; the two second roller carriers are arranged in an upper-and-lower manner and disposed beneath and above the continuous planar processed material respectively; the two second sealing rollers of the two second roller assemblies rollingly abut against an upper surface and a lower surface of the continuous planar processed material respectively.

9. The roller sealing device according to claim 7, wherein each first roller carrier includes a first gas access port, which is adjacent to the corresponding first auxiliary roller; each second roller carrier includes a second gas access port, which is adjacent to the corresponding second auxiliary roller.

10. The roller sealing device according to claim 9, wherein the first and second gas access ports are porous structures; the first and second gas access ports include a plurality of ventilators and connect an gas supply or a negative pressure generator.

11. The roller sealing device according to claim 7, further including an elastic member disposed between each first roller carrier and the continuous furnace, so that the two first roller carriers and the two first roller assemblies connect to the continuous furnace resiliently.

12. The roller sealing device according to claim 7, wherein the roller sealing device is disposed at an entrance of the continuous furnace, and another roller sealing device is disposed at an exit of the continuous furnace.

13. A gas-sealing method in a continuous furnace for processing a continuous planar material, comprising:
providing a pair of first roller carriers arranged correspondingly opposite to each other, each roller carrier comprising a first roller assembly having a first sealing roller and two first auxiliary rollers, a passage being defined between the pair of first roller carriers,
wherein at least one first gas access port is formed between the first auxiliary rollers and the first roller carriers,
wherein the rolling axis of the first sealing roller situates parallel between the rolling axes of the two first auxiliary rollers,
wherein the rolling axis of the first sealing roller situates between the rolling axis of the two first auxiliary rollers and the passage,
wherein the first auxiliary rollers rollingly abut against the first sealing roller;
providing a pair of second roller carriers arranged sequentially with respect to the first roller carries, the second roller carriers arranged correspondingly opposite to each other, each roller carrier comprising a second roller assembly having a second sealing roller and two second auxiliary rollers, the passage being defined between the pair of second roller carriers,
wherein at least one second gas access port is formed between the second auxiliary rollers and the second roller carriers,
wherein the rolling axis of the second sealing roller situates parallel between the rolling axes of the two second auxiliary rollers,
wherein the rolling axis of the second sealing roller situates between the rolling axes of the two second auxiliary rollers and the passage,
wherein the second auxiliary rollers rollingly abut against the second sealing roller; and,
conveying gas through the first gas access port to form a positive pressure state among the first auxiliary rollers and the first roller carriers, and extracting gas through the second gas access port to form a negative pressure state among the second auxiliary rollers and the second roller carriers.

14. The gas-sealing method according to claim 13, wherein a reaction region is defined in the continuous furnace to be positive or negative pressure.

15. The gas-sealing method according to claim 13, wherein the first and second gas access ports have porous structure, wherein the first and second gas access ports include a plurality of ventilators, wherein the first gas access port is in connection with a gas-providing source, and the second gas access port in connection with a gas extraction device.

16. The gas-sealing method according to claim 13, further including an elastic member disposed between each first roller carrier and the continuous furnace, so that the two first roller carriers and the two first roller assemblies connect to the continuous furnace resiliently.
